(19) United States
(12) Patent Application Publication
(10) Pub. No.: US 2010/0245013 A1
(43) Pub. Date: Sep. 30, 2010

(54) MULTILAYER ELECTRONIC COMPONENT

(75) Inventor: Toshio KAWABATA, Shiga-ken (JP)

Correspondence Address: Studebaker & Brackett PC, One Fountain Square, 11911 Freedom Drive, Suite 750, Reston, VA, 20190, US

(73) Assignee: MURATA MANUFACTURING CO., LTD., Kyoto-fu (JP)

(21) Appl. No.: 12/795,441

(22) Filed: Jun. 7, 2010

Related U.S. Application Data
(63) Continuation of application No. PCT/JP2008/071421, filed on Nov. 26, 2008.

(30) Foreign Application Priority Data
Dec. 7, 2007 (JP) 2007-316997

(51) Int. Cl. H01F 5/00

(52) U.S. Cl. 336/200

(57) ABSTRACT

A multilayer electronic component is provided which includes layers composed of different materials and bonded together and which is capable of suppressing the occurrence of delamination at a bonded portion between the layers composed of different materials. A magnetic first layer is composed of a material with relatively high magnetic permeability. A second magnetic layer is composed of a material with relatively low magnetic permeability. Boundary magnetic layers are provided between the two magnetic layers and include a partial magnetic layer composed of the same material as the first magnetic layer and a partial magnetic layer composed of the same material as the second magnetic layer. The partial magnetic layers are provided to be adjacent to each other in the boundary magnetic layers.

### CROSS REFERENCE TO RELATED APPLICATION

The present application is a continuation of International Application No. PCT/JP2008/071421 filed Nov. 26, 2008, which claims priority to Japanese Patent Application No. 2007-316997 filed Dec. 7, 2007, the entire contents of each of these applications being incorporated herein by reference in their entirety.

### BACKGROUND

1. Field of the Invention

The present invention relates to a multilayer electronic component and particularly to a multilayer electronic component in which a first insulating layer and a second insulating layer are laminated.

2. Description of the Related Art

There have been proposed multilayer electronic components including inductance and having various frequency characteristics. For example, Japanese Unexamined Patent Application Publication No. 2002-208515 has proposed a multilayer inductor including a laminate of high-permeability magnetic layers including a coil and a laminate of low-permeability magnetic layers including a coil. The multilayer inductor is capable of achieving a steep impedance characteristic at a low frequency and high impedance at a high frequency.

However, the multilayer inductor described in Japanese Unexamined Patent Application Publication No. 2002-208515 has the problem of delamination. Moreover, the multilayer inductor includes the laminates composed of different materials, and, thus, has weak bonding strength between the laminates. Therefore, delamination easily occurs between the laminates.

In addition, Japanese Patent No. 3251370 describes a composite multilayer component including an intermediate layer containing nonmagnetic ferrite and provided for preventing the precipitation of Cu and Cu oxides, Zn and Zn oxides, and the like at an interface between different materials. However, Japanese Patent No. 3251370 does not mention that the occurrence of delamination at an interface between different materials is prevented.

### SUMMARY

Embodiments consistent with the claimed invention can provide a multilayer electronic component which includes layers composed of different materials and bonded together and which is capable of suppressing the occurrence of delamination at a bonded portion between the layers composed of different materials.

A multilayer electronic component according to an embodiment includes a first insulating layer composed of a first material, a second insulating layer composed of a second material different from the first material, and a boundary layer provided between the first insulating layer and the second insulating layer and including a first partial layer composed of the first material and a second partial layer composed of the second material, wherein the first partial layer and the second partial layer are provided to be adjacent to each other as viewed in a lamination direction.

According another exemplary embodiment, in the boundary layer provided between the first insulating layer and the second insulating layer, the first partial layer and the second partial layer are adjacent to each other. Therefore, the first partial layer and the second partial layer are in contact with each other through the side surfaces. As a result, the contact area between the insulating layers composed of different materials can be increased, thereby suppressing the occurrence of delamination in the multilayer electronic component.

In another exemplary embodiment, the first partial layer may be provided so that the area of contact with the second insulating layer is larger than that with the first insulating layer.

In another exemplary embodiment, the boundary layer includes a first boundary layer provided on the first insulating layer side and a second boundary layer provided on the second insulating layer side, and the area of the first partial layer provided in the second boundary layer may be larger than the area of the first partial layer provided in the first boundary layer.

In to another exemplary embodiment, a plurality of the first insulating layers may be laminated to form a first laminate, and a plurality of the second insulating layers may be laminated to form a second laminate.

In another exemplary embodiment, the first laminate and the second laminate include a coil.

In another exemplary embodiment, the first partial layer and the second partial layer may be arranged in a checked pattern in the boundary layer.

According to embodiments consistent with the claimed invention, in a boundary layer disposed between a first insulating layer and a second insulating layer, a first partial layer and a second partial layer are provided to be adjacent to each other. Therefore, the first partial layer and the second partial layer are in contact with each other through the side surfaces. As a result, the contact area between the insulating layers composed of different materials can be increased, thereby suppressing the occurrence of delamination in the multilayer electronic component.

Other features, elements, characteristics and advantages of the embodiments consistent with the claimed inventions will become more apparent from the following detailed description with reference to the attached drawings.

### BRIEF DESCRIPTION OF DRAWINGS

FIG. 1 is a perspective view of the appearance of a multilayer electronic component according an exemplary embodiment consistent with the claimed invention.

FIG. 2 is an exploded perspective view of a laminate.

FIG. 3 is a process sectional view of a multilayer electronic component.

FIG. 4 is an exploded perspective view of a laminate of a multilayer electronic component according to a modified example.

### DETAILED DESCRIPTION

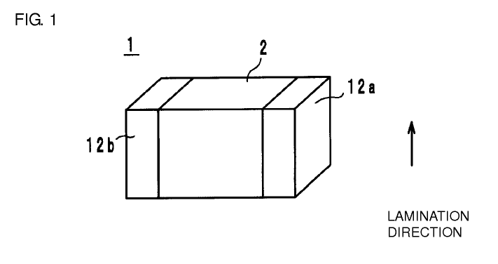

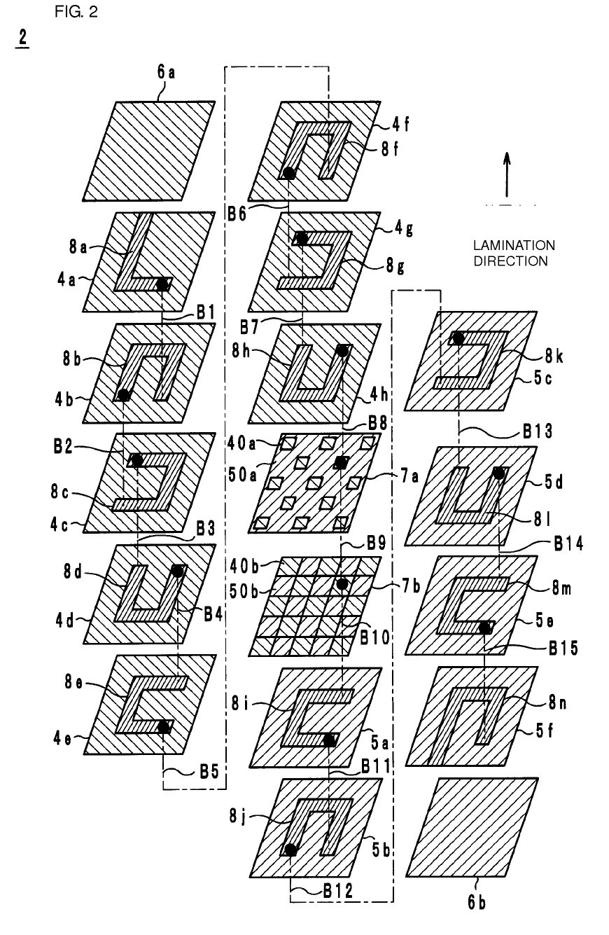

A multilayer electronic component according an exemplary embodiment is described below. The multilayer electronic component is used for, for example, an inductor, an impeder, a LC filter, and a LC composite component. FIG. 1 is a perspective view of the appearance of a multilayer electronic component 1, and FIG. 2 is an exploded perspective view of a laminate 2. Hereinafter, the direction in which ceramic green sheets are laminated when the multilayer electronic component 1 is formed is defined as the lamination direction.

As shown in FIG. 1, the multilayer electronic component 1 includes the laminate 2 having a rectangular parallelepiped shape and including a coil L therein, and two external electrodes 12a and 12b formed on the opposite sides (surfaces) of the laminate 2 and connected to the coil L.

The laminate 2 is realized by laminating a plurality of coil electrodes and a plurality of magnetic layers. Specifically, as shown in FIG. 2, the laminate 2 is realized by laminating a plurality of magnetic layers 4a to 4h, 5a to 5f, 6a, 6b, 7a, and 7b composed of high-permeability ferrite (e.g., Ni—Zn—Cu ferrite, Ni—Zn ferrite, or the like). The plurality of magnetic layers 4a to 4h, 5a to 5f, 6a, 6b, 7a, and 7b are rectangular insulating layers having substantially the same area and shape.

The magnetic layers 4a to 4h are composed of a material having relatively high permeability. In addition, coil electrodes 8a to 8h constituting the coil L are formed on the main surfaces of the magnetic layers 4a to 4h, respectively. Further, via hole conductors B1 to B8 are formed in the magnetic layers 4a to 4h, respectively.

The magnetic layers 5a to 5f are composed of a material different from that of the magnetic layers 4a to 4h. In more detail, the magnetic layers 5a to 5f are composed of a material having relatively low permeability. In addition, coil electrodes 8i to 8n constituting the coil L are formed on the main surfaces of the magnetic layers 5a to 5f, respectively. Further, via hole conductors B11 to B15 are formed in the magnetic layers 5a to 5e, respectively.

The magnetic layer 6a is composed of the same material as that of the magnetic layers 4a to 4h. The magnetic layer 6b is composed of the same material as that of the magnetic layers 5a to 5f. The coil electrodes 8a to 8n on the main surfaces and the via hole conductors B1 to B15 are not formed in the magnetic layers 6a and 6b.

The magnetic layers 7a and 7b are boundary layers provided between the magnetic layer 4h and the magnetic layer 5a. In further detail, the magnetic layer 7a is provided on the magnetic layer 4h side. On the other side, the magnetic layer 7b is provided on the magnetic layer 5a side. The configurations of the magnetic layers 7a and 7b are described in further detail below.

The magnetic layer 7b includes partial magnetic layers 40b and 50b. The partial magnetic layer 40b is composed of the same material as that of the magnetic layers 4a to 4h. The partial magnetic layer 50b is composed of the same material as that of the magnetic layers 5a to 5f. The partial magnetic layer 40b and the partial magnetic layer 50b are formed to be adjacent to each other as viewed from the lamination direction.

More specifically, the partial magnetic layer 40b and the partial magnetic layer 50b are formed in a square shape of the same size and arranged in a checked pattern. In other words, the partial magnetic layer 50b is in contact with each of the sides of the partial magnetic layer 40b, and the partial magnetic layer 40b is in contact with each of the sides of the partial magnetic layer 50b.

On the other hand, the magnetic layer 7a includes partial magnetic layers 40a and 50a. The partial magnetic layer 40a is composed of the same material as that of the magnetic layers 4a to 4h. The partial magnetic layer 50a is composed of the same material as that of the magnetic layers 5a to 5f.

The partial magnetic layer 40a and the partial magnetic layer 50a are formed to be adjacent to each other as viewed from the lamination direction. More specifically, the partial magnetic layer 40a is formed in a square shape having an area slightly smaller than that of the partial magnetic layer 40b and is disposed to overlap the partial magnetic layer 40b when the magnetic layer 7a and the magnetic 7b overlap each other. Further, the partial magnetic layer 50a is formed to fill the gap between the adjacent partial magnetic layers 40a.

In the magnetic layers 7a and 7b, the area of the partial magnetic layer 40b is larger than that of the partial magnetic layer 40a. Namely, the area of contact between the partial magnetic layer 40b and the magnetic layer 5a is larger than the area of contact between the partial magnetic layer 40a and the magnetic layer 4h. In addition, the area of the partial magnetic layer 50a is larger than that of the partial magnetic layer 50b. Namely, the area of contact between the partial magnetic layer 50a and the magnetic layer 4h is larger than the area of contact between the partial magnetic layer 50b and the magnetic layer 5a.

Further, a dielectric material or insulator may be used instead of the magnetic layers 4a to 4h, 5a to 5f, 6a, 6b, 7a, and 7b composed of ferrite. Hereinafter, when the magnetic layers 4a to 4h, 5a to 5f, 6a, 6b, 7a, and 7b, and the coil electrodes 8a to 8n are individually described, alphabet is added to each reference numeral. When the magnetic layers 4a to 4h, 5a to 5f, 6a, 6b, 7a, and 7b, and the coil electrodes 8a to 8n are generically named, the alphabet behind each reference numeral is omitted. In addition, when the via hole conductors B1 to B15 are individually described, a numeral is added behind alphabet B, and when the via hole conductors B1 to B15 are generically named, the numeral behind alphabet B is omitted.

Each of the coil electrodes 8 is composed of a conductive material including Ag and has a partially cut-away ring shape. In this embodiment, each of the coil electrodes 8 has a U-like shape. Therefore, each of the coil electrodes 8 constitutes an electrode having a length of ¾ turn. As shown in FIG. 2, the coil electrodes 8a and 8n are extended to the short sides of the magnetic layers 4a and 5f, respectively. The purpose of this is to connect the coil L and the external electrodes 12a and 12b. The coil electrodes 8 may be composed of a conductive material such as a noble metal containing Pd, Au, Pt, or the like as a main component or an alloy thereof, or the like. The coil electrodes 8 may be formed in a partially cut-away circular or elliptic shape.

Next, the via hole conductors B are described. The via hole conductors B are formed to pass through the magnetic layers 4, 5, and 7 in the vertical lamination direction in order to connect together the coil electrodes 8. Therefore, the coil electrodes 8 constitute the helical coil L.

In an exploded perspective view of FIG. 2, the magnetic layer 6a, the magnetic layers 4a to 4h, the magnetic layers 7a and 7b, the magnetic layers 5a to 5f, and the magnetic layer 6b are laminated in that order from above in the lamination direction to form the laminate 2. In addition, the external electrodes 12a and 12b are formed on the surface of the laminate 2 to produce the multilayer electronic component 1 shown in FIG. 1.

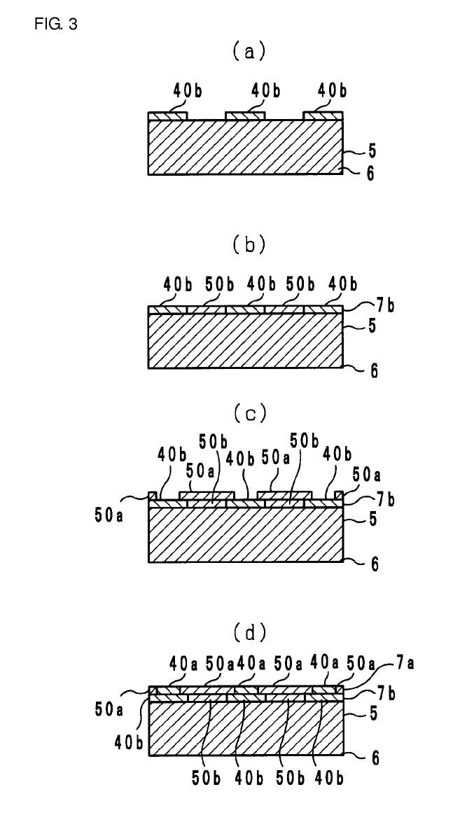

The method for manufacturing the multilayer electronic component 1 is described below with reference to FIGS. 2 and 3. FIG. 3 is a sectional view of the steps for the multilayer electronic component 1. In the manufacturing method described below, the multilayer electronic component 1 is formed by combining a sheet lamination method and a printing method.

A ceramic green sheet serving as each of the magnetic layers 4 and 6a is formed as follows:

Ferric oxide (Fe₂O₃), zinc oxide (ZnO), nickel oxide (NiO), and copper oxide (CuO) are weighed as raw materials at a predetermined ratio and charged in a ball mill, followed by wet mixing. The resultant mixture is dried and then ground, and the resultant powder is calcined at 800° C. for 1 hour. The resultant calcined powder is wet-ground in a ball mill, dried, and then disintegrated to prepare a ferrite ceramic powder having a particle diameter of 2 μm.

Then, a binder (e.g., vinyl acetate, water-soluble acryl, or the like), a plasticizer, a wetting material, and a dispersant are added to the ferrite ceramic powder and mixed in a ball mill, and the resultant mixture is degassed under reduced pressure. The resultant ceramic slurry is formed in a sheet by a doctor blade method and then dried to form a ceramic green sheet having a predetermined thickness of for example, 40 μm.

Next, a ceramic green sheet serving as each of the magnetic layers 5 and 6b is formed as follows. Ferric oxide (Fe₂O₃), zinc oxide (ZnO), nickel oxide (NiO), and copper oxide (CuO) are weighed as raw materials at a predetermined ratio and charged in a ball mill, followed by wet mixing. In this case, zinc oxide (ZnO) is mixed at a slightly lower ratio, and nickel oxide (NiO) is mixed at a slightly higher ratio. The resultant mixture is dried and then ground, and the resultant powder is calcined at 800° C. for 1 hour. The resultant calcined powder is wet-ground in a ball mill, dried, and then disintegrated to prepare a ferrite ceramic powder having a particle diameter of 2 μm.

Then, a binder (e.g., vinyl acetate, water-soluble acryl, or the like), a plasticizer, a wetting material, and a dispersant are added to the ferrite ceramic powder and mixed in a ball mill, and the resultant mixture is degassed under reduced pressure. The resultant ceramic slurry is formed in a sheet by a doctor blade method and then dried to form a ceramic green sheet having a predetermined thickness of, for example, 40 μm.

The via hole conductors B are formed in the respective ceramic green sheets serving as the magnetic layers 4a to 4h and 5a to 5e. Specifically, through holes are formed in the respective ceramic green sheets using a laser beam. Next, the through holes are filled with a conductive paste such as Ag, Pd, Cu, or Au or an alloy thereof by a method such as print coating or the like.

Next, a conductive paste composed of Ag, Pd, Cu, or Au or an alloy thereof as a main component is applied to each of the ceramic green sheets serving as the magnetic layers 4a to 4h and 5a to 5f by a method such as a screen printing method, a photolithographic method, or the like to form the coil electrodes 8. The coil electrodes 8 and the via hole conductors B may be simultaneously formed on each of the ceramic green sheets.

Next, the ceramic green sheets are laminated. Specifically, the ceramic green sheet serving as the magnetic layer 6b is disposed. Next, the ceramic green sheet serving as the magnetic layer 5f is disposed and temporarily pressure-bonded to the ceramic green sheet serving as the magnetic layer 6b. Then, similarly the ceramic green sheets serving as the magnetic layers 5e, 5d, 5c, 5b, and 5a are disposed in that order and temporarily pressure-bonded.

Next, layers serving as the magnetic layers 7b and 7a are formed on the ceramic green sheet serving as the magnetic layer 5a by a printing method. This method is described below with reference to FIG. 3. Hereinafter, the green partial magnetic layers 40a, 40b, 50a, and 50b are referred to as the partial magnetic layers 40a, 40b, 50a, and 50b for simplifying description.

First, as shown in FIG. 3(a), a paste composed of the same material as the magnetic layers 4 is applied on the magnetic layer 5 by a screen printing method to form the partial magnetic layer 40b. In this case, the partial magnetic layer 40b is not formed in a portion where the via hole conductor B1 is to be formed. Next, as shown in FIG. 3(b), a paste composed of the same material as the magnetic layers 5 is applied to portions, in which the partial magnetic layer 40b is not formed on the magnetic layer 5, by a screen printing method to form the partial magnetic layer 50b. Then, the via hole conductor B10 is formed by filling a conductive paste in the portion where the partial magnetic layer 40b is not formed.

Next, as shown in FIG. 3(c), a paste composed of the same material as the magnetic layers 5 is applied on the magnetic layer 7b by a screen printing method to form the partial magnetic layer 50a. In this case, the partial magnetic layer 50a is formed to completely cover the partial magnetic layer 50b. Next, as shown in FIG. 3(d), a paste composed of the same material as the magnetic layers 4 is applied to portions, in which the partial magnetic layer 50a is not formed on the magnetic layer 7b, by a screen printing method to form the partial magnetic layer 40a. The partial magnetic layer 40a is formed on the partial magnetic layer 40b to be smaller than the partial magnetic layer 40b. Further, the partial magnetic layer 40a is not formed in a portion in which the via hole conductor B9 is to be formed. Then, the via hole conductor B9 is formed by filling a conductive paste in the portion where the partial magnetic layer 40a is not formed.

Next, the ceramic green sheets serving as the magnetic layers 4h, 4g, 4f, 4e, 4d, 4c, 4b, 4a, and 6a are laminated in that order and temporarily pressure-bonded to the ceramic green sheet serving as the magnetic layer 7a. As a result, the green laminate 2 is formed. The green laminate 2 is subjected to main pressure-bonding by hydrostatic pressure pressing or the like.

Next, the laminate 2 is subjected to binder removal and firing. The binder removal is performed under conditions, for example, at 400° C. for 3 hours. The firing is performed under conditions, for example, at 900° C. for 2 hours. As a result, the fired laminate 2 is prepared. Then, an electrode paste containing silver as a main component is applied by, for example, a method such as dipping or the like and baked on the surface of the laminate 2 to form the external electrodes 12a and 12b. As shown in FIG. 1, the external electrodes 12a and 12b are formed on the right and left end surfaces of the laminate 2. The coil electrodes 8a and 8n are electrically connected to the external electrodes 12a and 12b, respectively.

Finally, Ni plating/Sn plating is performed on the surfaces of the external electrodes 12a and 12b. The multilayer electronic component 1 shown in FIG. 1 is completed through the above-described steps.

### (Effect)

In the above-described multilayer electronic component 1, in the magnetic layers 7a and 7b disposed between the laminate of the magnetic layers 4 and the laminate of the magnetic layers 5, the partial magnetic layers 40a and 50a are disposed to be adjacent to each other in a plane, and the partial magnetic layers 40b and 50b are disposed to be adjacent to each other in a plane. Therefore, the partial magnetic layer 40a and the partial magnetic layer 50a are in contact with each other through the sides, and the partial magnetic layer 40b and the partial magnetic layer 50b are in contact with each other through the sides. As a result, the contact area between magnetic layers of different materials can be increased, thereby suppressing the occurrence of delamination in the multilayer electronic component 1.

Further, in the multilayer electronic component 1, the area of the partial magnetic layer 50b is smaller than the area of the partial magnetic layer 50a, and the area of the partial magnetic layer 40a is smaller than the area of the partial magnetic layer 40b. As described below, therefore, the occurrence of delamination in the multilayer electronic component 1 can be effectively suppressed.

As shown in FIG. 3, for example, the bottom surface of the partial magnetic layer 50b is in contact with the magnetic layer 5a, and the top surface thereof is in contact with the partial magnetic layer 50a. In addition, the top surface of the partial magnetic layer 50a is in contact with the magnetic layer 4h. The partial magnetic layer 50a and the magnetic layer 4h are composed of different materials, and the partial magnetic layers 50a and 50b and the magnetic layer 5a are composed of the same material. Therefore, the bonding strength between the partial magnetic layer 50a and the magnetic layer 4h is smaller than that between the partial magnetic layer 50a and the partial magnetic layer 50b and between the partial magnetic layer 50b and the magnetic layer 5a. Thus, when delamination possibly occurs in the multilayer electronic component 1, delamination tends to occur between the partial magnetic layer 50a and the magnetic layer 4h or between the partial magnetic layer 50b and the magnetic layer 5a.

However, since the partial magnetic layer 50a is formed to be larger than the partial magnetic layer 50b, the bottom surface of the partial magnetic layer 50a partially overlaps the top surface of the partial magnetic layer 40b. In addition, since the partial magnetic layer 40b is formed to be larger than the partial magnetic layer 40a, the top surface of the partial magnetic layer 40b partially overlaps the bottom surface of the partial magnetic layer 50a. As a result, the occurrence of delamination in the multilayer electronic component 1 can be effectively suppressed.

In addition, the partial magnetic layer 40b and the partial magnetic layer 50b are arranged in a checked pattern so that the partial magnetic layer 40b and the partial magnetic layer 50b are in contact with each other through the side surfaces in a wider area. As a result, the area of contact between magnetic layers of different materials can be increased, and the occurrence of delamination in the multilayer electronic component 1 can be effectively suppressed.

In the multilayer electronic component 1, the magnetic layers 7a and 7b composed of the same materials as the magnetic layers 4 and 5 are provided in the boundary between the laminate of a plurality of the magnetic layers 4 and the laminate of a plurality of the magnetic layers 5, thereby suppressing the occurrence of delamination in the multilayer electronic component 1. Namely, a layer composed of a new material for bonding these laminates is not provided. Consequently, the multilayer electronic component 1 causing little delamination can be manufactured at low cost.

In addition, the partial magnetic layer 40b and the magnetic layer 5a composed of different materials are formed by a printing method. Therefore, the adhesion between the partial magnetic layer 40b and the magnetic layer 5a is improved as compared with the case in which the partial magnetic layer 40b and the magnetic layer 5a are formed by a sheet lamination method.

Further, the magnetic layers 4 and 5 with the coil electrodes 8 formed thereon are laminated by the sheet laminating method. Therefore, the length of the coil L may be changed only by adding new magnetic layers 4 and 5 with the electrodes 8 formed thereon. As a result, in the multilayer electronic component 1, the length of the coil L can be easily changed as compared with the case in which the magnetic layers 4 and 5 with the coil electrodes 8 formed thereon are laminated by the printing method.

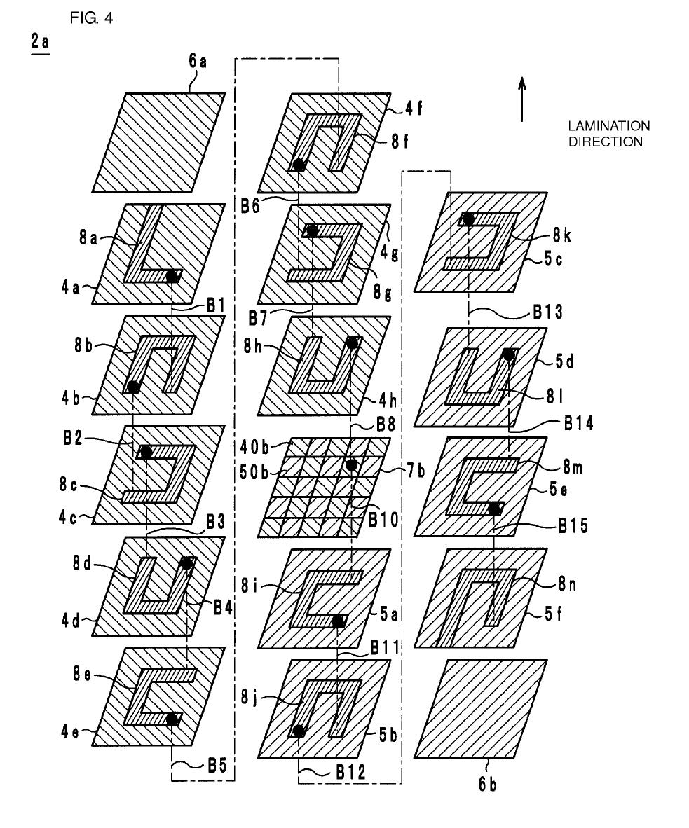

In addition, the multilayer electronic component 1 is not limited to the above-described embodiment, and modifications can be made within the scope of the gist. FIG. 4 is an exploded perspective view of a laminate 2a of a multilayer electronic component 1a according to a modified example. In the laminate 2a shown in FIG. 4, the same configuration as in the laminate 2 shown in FIG. 2 is denoted by the same reference numeral.

The difference between the laminate 2 shown in FIG. 2 and the laminate 2a shown in FIG. 4 lies in the point that the magnetic layer 7a is provided in the laminate 2, while the magnetic layer 7a is not provided in the laminate 2a.

In the laminate 2a, the partial magnetic layer 40b and the partial magnetic layer 50b are in contact with each other through the sides thereof. Therefore, the area of contact between magnetic layers of different materials can be increased, thereby suppressing the occurrence of delamination in the multilayer electronic component 1a.

Although the multilayer electronic component 1 uses the ¾-turn coil electrodes 8, for example, ⅚-turn coil electrodes 8 or ⅞-turn coil electrodes may be used.

Although, in the method for manufacturing the multilayer electronic component 1, the multilayer electronic component 1 is formed by combining a sheet laminating method and a printing method, the method for manufacturing the multilayer electronic component 1 is not limited to this. For example, the multilayer electronic component 1 may be formed only by a printing method.

In the multilayer electronic components 1 and 1a, the expression “composed of different materials” includes the case in which the constituent raw materials are different and the case in which the mixing ratios of the same raw material are different.

As described above, the embodiments consistent with the claimed invention are advantageous for multilayer electronic components and are particularly excellent in that the occurrence of delamination is suppressed.

Although a limited number of embodiments are described herein, one of ordinary skill in the art will readily recognize that there could be variations to any of these embodiments and those variations would be within the scope of the appended claims. Thus, it will be apparent to those skilled in the art that various changes and modifications can be made to the communication system described herein without departing from the scope of the appended claims and their equivalents.

1. A multilayer electronic component comprising:
a first insulating layer composed of a first material;
a second insulating layer composed of a second material different from the first material; and
a boundary layer provided between the first insulating layer and the second insulating layer and including a first partial layer composed of the first material and a second partial layer composed of the second material,
wherein the first partial layer and the second partial layer are positioned adjacent to each other in a lamination direction.

2. The multilayer electronic component according to claim 1, wherein the first partial layer is provided so that the contact area with the second insulating layer is larger than the contact layer with the first insulating layer.

3. The multilayer electronic component according to claim 2, wherein the boundary layer comprises:
a first boundary layer provided on the first insulating layer side; and
a second boundary layer provided on the second insulating layer side, the area of the first partial layer provided in the second boundary layer being larger than the area of the first partial layer provided in the first boundary layer.

4. The multilayer electronic component according to claim 1, further including a plurality of said first insulating layer and a plurality of said second insulating layer, said a plurality of the first insulating layer being laminated to form a first laminate, and said plurality of the second insulating layer being laminated to form a second laminate.

5. The multilayer electronic component according to claim 4, wherein the first laminate and the second laminate include a coil.

6. The multilayer electronic component according to claim 5, wherein the first partial layer and the second partial layer are arranged in a checked pattern in the boundary layer.

7. The multilayer electronic component according to claim 2, further including a plurality of said first insulating layer and a plurality of said second insulating layer, said plurality of the first insulating layer being laminated to form a first laminate, and said plurality of the second insulating layer being laminated to form a second laminate.

8. The multilayer electronic component according to claim 7, wherein the first laminate and the second laminate include a coil.

9. The multilayer electronic component according to claim 6, wherein the first partial layer and the second partial layer are arranged in a checked pattern in the boundary layer.

10. The multilayer electronic component according to claim 3, further including a plurality of said first insulating layer and a plurality of said second insulating layer, said plurality of the first insulating layer being laminated to form a first laminate, and said plurality of the second insulating layer being laminated to form a second laminate.

11. The multilayer electronic component according to claim 5, wherein the first laminate and the second laminate include a coil.

12. The multilayer electronic component according to claim 6, wherein the first partial layer and the second partial layer are arranged in a checked pattern in the boundary layer.
